(19) United States
(12) Patent Application Publication
(10) Pub. No.: US 2011/0150429 A1
(43) Pub. Date: Jun. 23, 2011

(54) RECORDING AND PLAYBACK DEVICE, RECORDING AND PLAYBACK METHOD, AND COMPUTER PROGRAM PRODUCT RECORDING AND PLAYBACK

(76) Inventor: Yoshihiro Kaneko, Fussa-shi (JP)

(21) Appl. No.: 12/879,660

(22) Filed: Sep. 10, 2010

(30) Foreign Application Priority Data
Dec. 18, 2009 (JP) 2009-288264

(51) Int. Cl. H04N 5/76

(52) U.S. Cl. 386/291; 386/E05.003

(57) ABSTRACT

In one embodiment, a recording and playback device includes: a tuner receiving a broadcast wave including program data; a display displaying the program data; a detector detecting an object being present in a direction of a screen of the display using infrared rays; a determination module determining a presence or absence of a viewer based on a signal from the detector; and a recording and playback controller recording and playback the program data in accordance with a judgment of the determination module, wherein when a viewer is determined to be absent, the recording and playback controller starts recording the program data and sets a recording start position at which the recording of the program data is started as a playback start position, and when the viewer is determined to be present during recording of the program data, the recording and playback controller starts playing back the program data from the playback start position while continuing to record the program data.

### CROSS-REFERENCE TO RELATED APPLICATIONS

This application is based upon and claims the benefit of priority from Japanese Patent Application No. 2009-288264, filed on Dec. 18, 2009, the entire contents of which are incorporated herein by reference.

### FIELD

Embodiments described herein relate generally to a recording and playback device, a recording and playback method and computer program product recording and playback.

### BACKGROUND

Conventionally, a recording and playback device which records and plays back program data broadcasted from a TV station is known. As such a recording and playback device, there are a personal computer (PC) or a recording device to which a tuner is added externally or internally to record the program data received by the tuner into a storage device such as a hard disc, and a television receiving device to which a storage device such as a hard disc is added externally or internally to record program data into the storage device.

As a technique related to the above mentioned recording and playback device, a technique in which even when a viewer left a program watching position in the middle of viewing a program, the viewer can view the part of the program which the viewer did not view during the user left the program watching position is conventionally proposed.

### BRIEF DESCRIPTION OF THE SEVERAL VIEWS OF THE DRAWINGS

FIG. 1 is an exemplary schematic top perspective view of a recording and playback device according to an embodiment;

FIG. 2 is an exemplary schematic top view of the recording and playback device for illustrating a sensing area of a human detector in the embodiment;

FIG. 3 is an exemplary schematic side view of the recording and playback device for illustrating the sensing area of the human detector in the embodiment;

FIG. 4 is an exemplary block diagram of the recording and playback device in the embodiment;

FIG. 5 is an exemplary flow chart of a viewing support processing in the embodiment; and

FIG. 6 is an exemplary flow chart of a return processing in the embodiment

### DETAILED DESCRIPTION

In general, according to one embodiment, a recording and playback device comprises: a tuner, a display, a detector, a determination module, and a recording and playback controller. The tuner is configured to receive a broadcast wave including program data. The display is configured to display the program data. The detector is configured to detect an object which is present in a direction of a display screen of the display by using infrared rays. The determination module is configured to determine a presence or absence of a viewer based on a detection signal from the detector. The recording and playback controller is configured to record and play back the program data in accordance with a determination result of the determination module. When it is determined that a viewer is absent, the recording and playback controller is configured to start recording the program data and set a recording start position at which the recording of the program data is started as a playback start position, and when it is determined that the viewer is present during recording of the program data, the recording and playback controller is configured to start playing back the program data from the playback start position while continuing to record the program data.

According to another embodiment of the invention, a recording and playback method comprises: receiving, using a tuner, a broadcast wave including program data; displaying, using a display, the program data; detecting, using a detector, an object which is present in a direction of a display screen of the display by using infrared rays; determining, using a determination module, a presence or absence of a viewer based on a detection signal from the detector; and recording and playback, using a recording and playback controller, the program data in accordance with the determination result, wherein when it is determined that a viewer is absent, the recording and playback controller is configured to start recording the program data and set a recording start position at which the recording of the program data is started as a playback start position, and when it is determined that the viewer is present during recording of the program data, the recording and playback controller is configured to start playing back the program data from the playback start position while continuing to record the program data.

According to still another embodiment of the invention, a computer program product having a computer readable medium including programmed instructions, wherein the instructions, when executed by a computer, cause the computer to perform: receiving, using a tuner, a broadcast wave including program data; displaying, using a display, the program data; detecting, using a detector, an object which is present in a direction of a display screen of the display by using infrared rays; determining, using a determining module, a presence or absence of a viewer based on a detection signal from the detector; and recording and playback, using a recording and playback controller, the program data in accordance with the determination result, wherein when it is determined that a viewer is absent, the recording and playback controller is configured to start recording the program data and set a recording start position at which the recording of the program data is started as a playback start position, and when it is determined that the viewer is present during recording of the program data, the recording and playback controller is configured to start playing back the program data from the playback start position while continuing to record the program data.

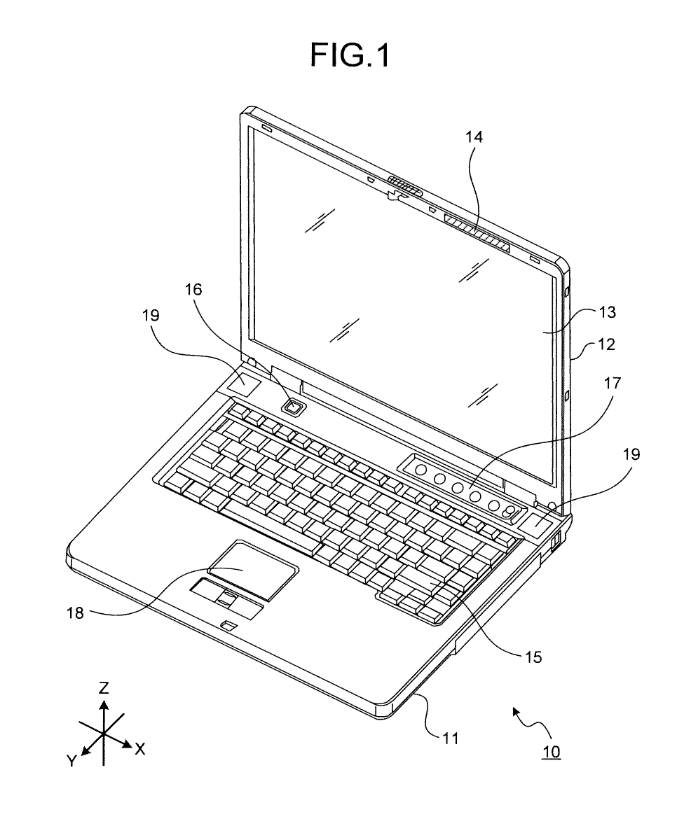

In one embodiment, a recording and playback device, a method and program for recording and playback program data will now be explained in detail with reference to FIGS. 1 to 6. In the embodiment, for example, as a recording and playback device, a notebook personal computer (PC) is applied, which is hereinafter referred to as computer.

FIG. 1 is an exemplary top perspective view of a computer whose display unit is in an open state in the embodiment. A computer 10 comprises a body 11 and a display unit 12. In the display unit 12, a display device composed of an LCD (Liquid Crystal Display) 13 and so on is mounted. The display screen of the LCD 13 is mounted at nearly the center of the display unit 12.

The display unit 12 is attached to the body 11 to be rotatable between an open position and a closed position. To an outer frame of the LCD 13 in the display unit 12, a human detector 14 is attached. The human detector 14 is a pyroelectric or reflection infrared sensor, and emits infrared rays in a display screen direction of the LCD 13 to detect an object which is present in the display screen direction.

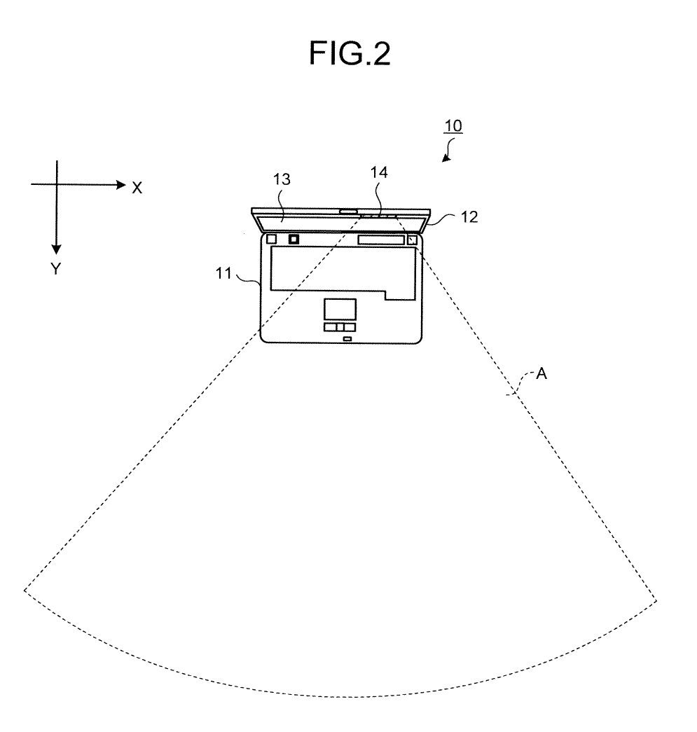

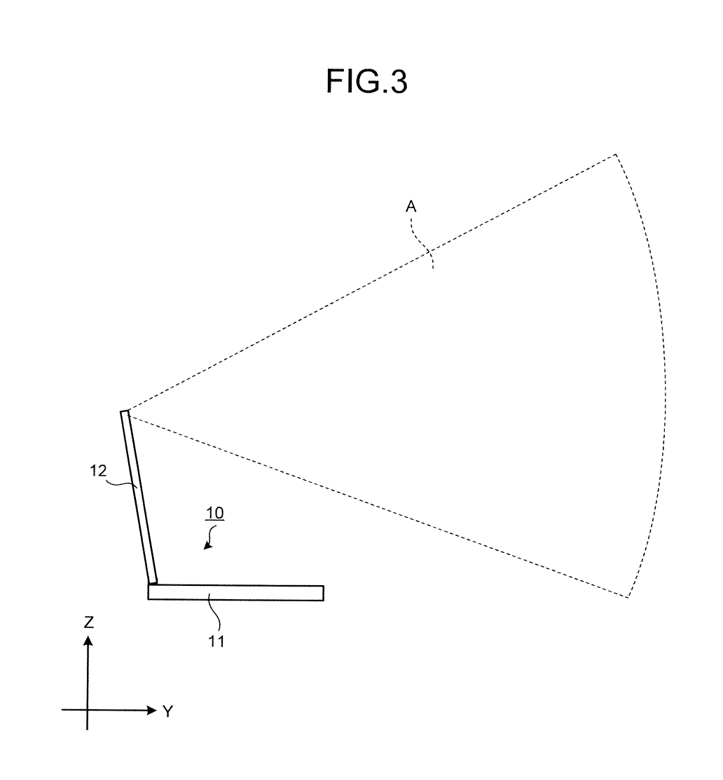

With reference to FIG. 2 and FIG. 3, an area where the human detector 14 can detect (hereinafter referred to as sensing area) will be described below. FIG. 2 is an exemplary schematic top view of the computer 10 for illustrating a sensing area A of the human detector 14. FIG. 3 is an exemplary schematic left side view of the computer 10 for illustrating the sensing area A of the human detector 14.

As illustrated in FIG. 2 and FIG. 3, the sensing area of the human detector 14 is designed to extend in a direction facing the display unit 12 which is in an open state, that is to say, in the display screen direction of the LCD 13. The human detector 14 detects an object which is present in the sensing area to output the detection signal to a CPU 111 via an Embedded controller/Keyboard Controller (EC/KBC) 122, a south bridge 116, and a north bridge 112.

It is more preferable that the sensing area of the human detector 14 corresponds to the field of view of the display screen of the LCD 13 to be normally seen. An arrangement position of the human detector 14 is not limited to this, but can be any other position such as the side portion of the body 11 that the sensing area can be realized in the display screen direction of the LCD 13.

Referring back to FIG. 1, the body 11 has a thin box-shaped casing on which a keyboard 15, a power button 16 to turn on and off a power supply, an input operation panel 17, a touch pad 18, a speaker 19, and so on are provided.

The input operation panel 17 is for inputting to a system an event corresponding to a button pressed by a user, and includes a plurality of buttons for starting up a plurality of functions, respectively. For example, the input operation panel 17 includes a TV start button to start up a function to watch and record and play back a TV broadcasting (program). When the TV start button is pressed by a user, a TV function program described later to realize a TV function is automatically started.

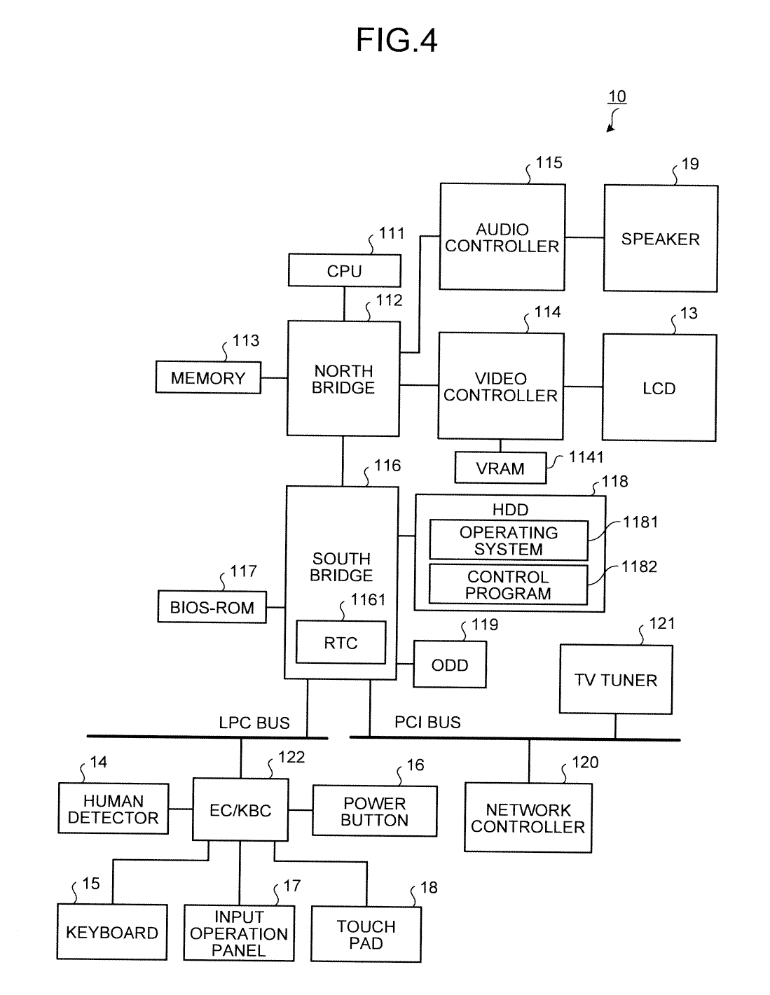

Next, a system configuration of the computer 10 will be explained with reference to FIG. 4. FIG. 4 is an exemplary block diagram of the computer 10.

As illustrated in FIG. 4, the computer 10 comprises the CPU 111, the north bridge 112, a memory 113, a video controller 114, an audio controller 115, the south bridge 116, a BIOS-ROM 117, a hard disc drive (HDD) 118, an optical disc drive (ODD) 119, a network controller 120, a TV tuner 121, and the EC/KBC 122. In FIG. 4, the CPU 111 is connected to the above mentioned modules via the north bridge 112 and the south bridge 116, but the connection is not limited to this, but the CPU 111 can be connected to the above mentioned modules via a single bus, for example.

The CPU 111 is a processor for controlling the operations of the computer 10, and executes a system BIOS (Basic Input Output System) stored in the BIOS-ROM 117. The system BIOS is a program for controlling a hardware.

The CPU 111 executes an operating system 1181 which is loaded from the HDD 118 to the memory 113, and a variety of control programs 1182 including a TV function program.

Here, the TV function program is application program to cause a variety of functions (TV function) regarding viewing program data broadcasted from a TV station to be realized. Specifically, the TV function program includes a function to record the program data (hereinafter simply referred to as program) received by the TV tuner 121 into a specific area of the HDD 118 via the north bridge 112 and the south bridge 116 to play back the recorded program.

The TV function program includes a function to improve image quality of video data included in the program received by the TV tuner 121 and the program to be played back. The program of which image quality is improved by the control programs 1182 is written into a video memory (VRAM) 1141 of the video controller 114 and audio data included in the program is output to the audio controller 115.

The function program has a function to obtain additional information such as a broadcast schedule (a broadcast station, a broadcast start date, a broadcast end time, and so on) and program table indicating contents of programs via the TV tuner 121, and outputs the additional information to the video controller 114 via the north bridge 112 to display on the LCD 13.

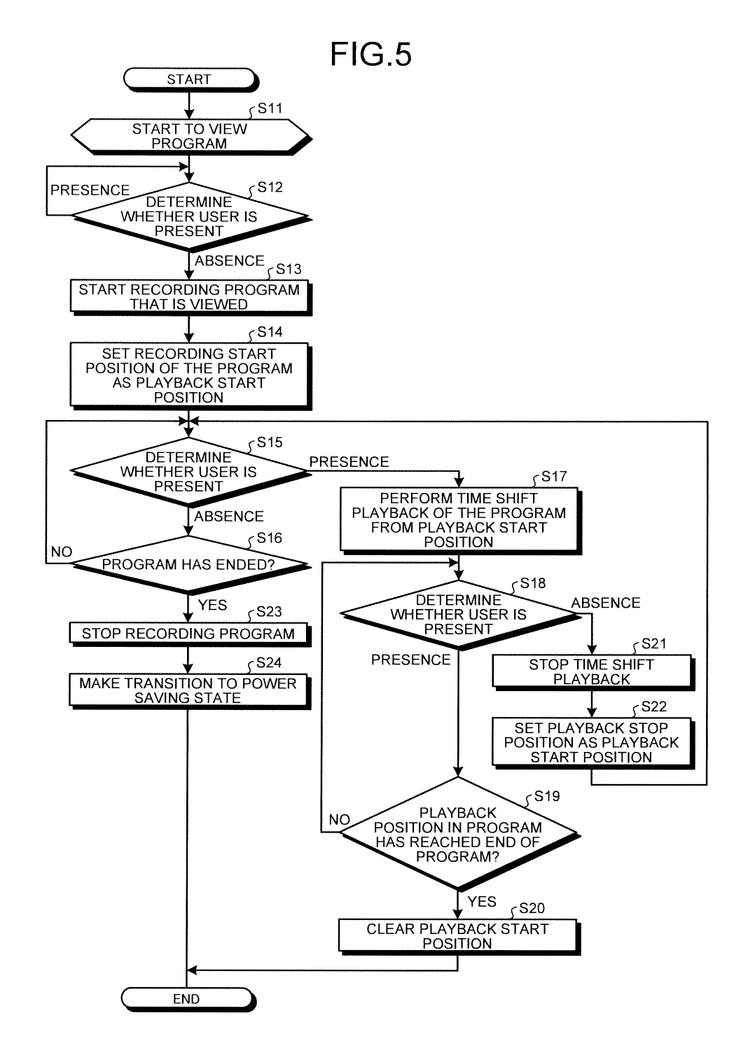

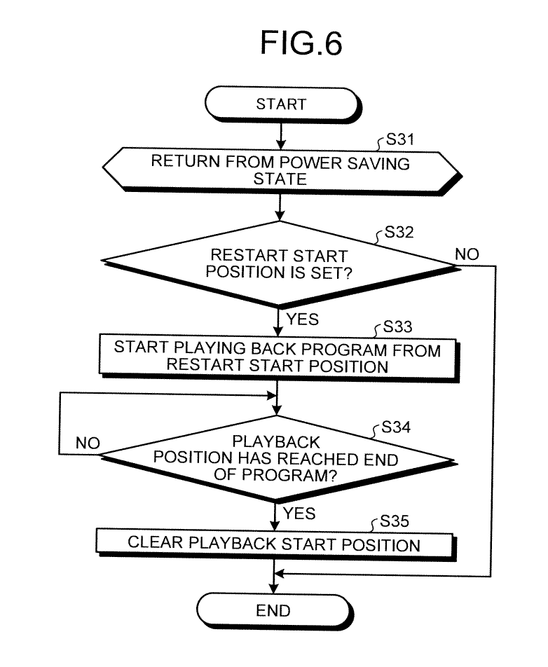

Further, the TV function program has a function to perform a viewing support process (FIG. 5) and a return process (FIG. 6) described later. The TV function program can be performed on the operating system 1181, or can be performed independently of the operating system 1181.

The north bridge 112 is a bridge device which connects a local bus of the CPU 111 and the south bridge 116. The north bridge 112 includes a memory controller (not illustrated) to enforce access control to the memory 113. The north bridge 112 has a function to perform communication with each of the video controller 114 and the audio controller 115 via AGP (Accelerated Graphics Port) bus, and so on.

The memory 113 is a volatile memory as a main storage device of the computer 10, and functions as a work area when the CPU 111 performs the variety of control programs 1182.

The video controller 114 is a display controller to control the LCD 13 used as a display monitor of the computer 10. The video controller 114 displays the video data written into the VRAM 1141 on the LCD 13.

The audio controller 115 is an audio playback controller to control an audio output by the speaker 19 of the computer 10. The audio controller 115 outputs, audio data which is input through the north bridge 112, from the speaker 19.

The south bridge 116 controls a plurality of devices connected to a LPC (Low Pin Count) bus and a plurality of devices connected to a PCI (Peripheral Component Interconnect) bus. The south bridge 116 includes a controller such as the IDE (Integrated Drive Electronics) and the ATAPI (Advanced Technology Attachment Packet Interface) to control the HDD 118 and the ODD 199. The south bridge 116 includes an RTC (Real Time Clock) 1161 to count time. Further, the south bridge 116 has a function to control the network controller 120 and the TV tuner 121, and a function to enforce access control to the BIOS-ROM 117.

The HDD 118 is an auxiliary storage device of the computer 10 to store the operating system 1181, the control programs 1182, setting information (not illustrated), and so on. The ODD 119 is a drive unit to drive storage medium such as a DVD (Digital Versatile Disc) and a CD (Compact Disc) which stores video contents. The network controller 120 is a communication device to communicate with an external network such as the Internet. The TV tuner 121 is a receiver to receive a TV broadcast wave of analog or digital broadcast.

The EC/KBC 122 is a micro computer in which an embedded controller (EC) for managing electric power and a keyboard controller (KBC) for controlling the keyboard 15 and the touch pad 18 are integrated. The EC/KBC 122 has a function to turn on and off the computer 10 in accordance with the operation of the power button 16 by a user. The EC/KBC 122 has a function to turn on the computer 10 in accordance with the operation of the button of the input operation panel 17 by a user.

In the above mentioned configuration, when the power button 16 is pressed by a user, electric power is supplied to the devices of the computer 10 from a power supply device (not illustrated), and the operating system is started by the CPU 111. On the other hand, when a predetermined time elapses in a state that the keyboard 15 and the touch pad 18 are not operated, or the CPU 111 determines that no user is present based on the detecting result by the human detector 14 and recording a program is ended in the viewing support process described later, the CPU 111 controls the amount of power supplied from the power supply device to cause the computer 10 to make a transition to a power saving state such as a standby and a hibernation.

In the power saving state of the computer 10, the power supply device is controlled such that power is supplied to only the EC/KBC 122, and the amount of the power consumption of the entire computer 10 is suppressed to be lower than that during a normal operation period. The EC/KBC 122 causes the power supply device to start supplying power to the devices (the human detector 14, the keyboard 15, the power button 16, the input operation panel 17, and the touch pad 18) which are connected to the EC/KBC 122 in accordance with the detection signal with respect to the devices during the power saving operation period to cause the computer 10 to return (wake up) from the power saving state.

The operations of the computer 10 will be described with reference to FIG. 5. FIG. 5 is an exemplary flow chart of a viewing support processing performed by cooperation between the CPU 111 and the TV function program. As a precondition of the processing, the TV start button of the input operation panel 17 is pressed by a user, and a program is being viewed in the background (S11).

First, the CPU 111 determines whether a user is present in the sensing area of the human detector 14, that is to say, a viewer of a program displayed on the LCD 13 is present based on the detection signal of the human detector 14 (S12).

For example, if a reflection infrared sensor is used as the human detector 14, it is possible to determine whether a user is present based on the following reference. Specifically, if no change occurs in the detecting distance of the human detector 14 for a first predetermined period (hereinafter referred to as absence of user judgment time), it is determined that no user is present. If a change occurs in the detecting distance of the human detector 14 for a second predetermined period (hereinafter referred to as presence of user judgment time), it is determined that a user is present. Counts of the absence of user judgment time and the presence of user judgment time are performed based on a bus clock supplied through the local bus of the CPU 111, or time information obtained from the RTC 1161 of the south bridge 116 and so on.

If a pyroelectric infrared sensor is used as the human detector 14, it is possible to determine whether a user is present based on the following reference. Specifically, if no dynamic body is detected for the absence of user judgment time, it is determined that no user is present. If a dynamic body is continuously detected for more than the presence of user judgment time, it is determined that a user is present.

As above mentioned, in the embodiment, because an infrared sensor whose power consumption is lower than an image pickup device is used as the human detector 14, and a presence or absence of a viewer is determined based on a change in the detection signal by the infrared sensor, it is possible to realize a presence or absence of a viewer judgment with a simple configuration.

Arbitrary values can be set as the absence of user judgment time and the presence of user judgment time, respectively. It is more preferable to determine that a user is present only if it is determined that a change in the detected position remains within the sensing area even after the presence of user judgment time has elapsed based on a temporal change in the detected position within the sensing area.

When it is determined that a user is present at S12 (Presence at S12), the CPU 111 continues to monitor the detection signal by the human detector 14 without performing S13 or later. On the other hand, when it is determined that no user is present at S12 (Absence at S12), the CPU 111 starts recording a program that is viewed at the present time (S13). The recording of the program is continued till the broadcast end time based on the broadcast schedule (the broadcast station, the broadcast start date, the broadcast end time, and so on) included in program information of the program.

Next, the CPU 111 sets a recording start position of the program of which the recording is started at S13, that is to say, a beginning of the program which is being recorded at the present time as a position at which the playback of the program is started (hereinafter referred to as playback start position) (S14).

Next, the CPU 111 determines that a user is present in the sensing area of the human detector 14 based on the detection signal from the human detector 14 (S15). When it is determined that no user is present (Absence at S15), the CPU 111 determines whether the program which is being recorded has ended, that is to say, it has reached the broadcast end time of the program (S16). If it has not reached the broadcast end time (No at S16), it returns back to S15, again.

When it is determined that a user exits at 515 (Presence at S15), the CPU 111 performs a time shift playback of the program in which the program being recorded is played back (time-shift playback) from the playback start position set right before (S17). Thus, the user can view the scene (the program) of during the user's absence. As a technology for the time shift playback, a technology known or used by others can be used.

Next, the CPU 111 determined whether a user is present in the sensing area of the human detector 14 based on the detection signal from the human detector 14 (S18). When it is determined that a user is present (Presence at S18), the CPU 111 determines whether the playback position at which the time shift playback is performed in the program has reached the end of the program (S19). When it is determined that the playback position has reached the end of the program (Yes at S19), the CPU 111 clears the playback start position (S20), and then ends this processing.

When it is determined that the playback position has not reached the end of the program (No at S19), it returns back to S18. At S18, if the CPU 111 determines that no user is present (Absence at S18), the CPU 111 stops the time shift playback (S21), and resets this playback stop position as the playback start position (S22), and then it returns back to S15, again.

On the other hand, at 516, when it is determined that the program to be recorded has ended (Yes at S16), the CPU 111 stops recording the program (S23), and causes the computer 10 to make a transition to the power saving state (S24), and then ends this processing.

Thus, even when a user left the program watching position in the middle of viewing the program, if the user returns to the program watching position before the program ends, the user can view the part of the program which was broadcasted during the user left the program watching position. If the user does not return to the program watching position before the program ends, it is possible to prevent unnecessary power consumption because the computer 10 is caused to make the transition to the power saving state.

Next, the operation of when the computer 10, which is caused to be in the power saving state at S24, returns from the power saving state will be described with reference to FIG. 6. FIG. 6 is an exemplary flow chart of a return processing performed by the cooperation between the CPU 111 and the TV function program.

When the EC/KBC 122 starts supplying power to the human detector 14, the keyboard 15, the power button 16, the input operation panel 17, and the touch pad 18 in accordance with the detection signal from the human detector 14, the keyboard 15, the power button 16, the input operation panel 17, or the touch pad 18, the computer 10 is caused to return from the power saving state (S31). In returning from the power saving state, the CPU 111 determines whether the playback start position is set (S32). If the CPU 111 determines that the playback start position is not set (No at S32), the CPU 111 ends this processing immediately to restore the operation performed before the transition is made to the power saving state.

On the other hand, if the CPU 111 determines that the playback start position is set (Yes at S32), the CPU 111 starts playing back, from the playback start position, the program which is recorded before the transition is made to the power saving state, that is to say, the program which is recorded in the viewing support process illustrated in FIG. 5 (S33).

When the CPU 111 determines that the playback position of the program played back at S33 has reached the end of the program (Yes at S34), the CPU 111 clears the playback start position (S35), and then ends this processing. If other process such as a switching of the program is instructed in the middle of the playback of the program, the CPU 111 ends this processing immediately to perform the instructed process.

Thus, even if a user left the program watching position in the middle of viewing the program, and returns to the program watching position after the program ends, the user can view the part of the program which was broadcasted during the user left the program watching position.

As mentioned above, according to the embodiment, a presence or absence of a viewer is determined based on the detection signal of the human detector 14 using infrared rays, and if it is determined that no viewer is present, recording of the program is started, and the recording start position is set as a playback start position, and if it is determined that a viewer is present in the middle of recording the program, the time shift playback is performed from the playback start position. Thus, even when a viewer left the program watching position in the middle of viewing the program, if the viewer returns to the program watching position, the part of the program which the viewer did not view during the viewer left the program watching position is automatically played back. Therefore, it is possible to provide the viewing support of when the viewer left the program watching position in the middle of playback the program, with a simpler configuration.

As mentioned above, the embodiment is explained, however, is not limited to this. For example, in the above mentioned embodiment, the time shift playback is performed immediately after it is determined that a user is present, but it is not limited to this. As substitute for performing the time shift playback, a confirmation screen, to allow the user to confirm whether the time shift playback is performed, can be displayed on the LCD 13.

In the above mentioned embodiment, as a recording and playback device, the computer 10 is used, but it is not limited to this. For example, a recording device which can record program data received by a tuner into a storage device such as a hard disc, and a television receiving device to which a storage device such as a hard disc is added externally or internally to record program data into the storage device can be applied.

In the above mentioned embodiment, the TV function program is pre-installed on the HDD 118, but it is not limited to this. As an installable file, or an executable file, the TV function program can be stores into a computer readable recording medium such as a CD-ROM, a flexible disc (FD), a CD-R, a DVD to be distributed.

The TV function program can be provided by storing the TV function program into a computer connected to a network such as the Internet and downloading the TV function program from the computer via the network. The TV function program can be provided or distributed via a network such as the Internet.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording and playback device comprising:
a tuner configured to receive a broadcast wave including program data;
a display configured to display the program data;
a detector configured to detect an object which is present in a direction of a display screen of the display by using infrared rays;
a determination module configured to determine a presence or absence of a viewer based on a detection signal from the detector; and
a recording and playback controller configured to record and play back the program data in accordance with a determination result of the determination module,
wherein when it is determined that a viewer is absent, the recording and playback controller is configured to start recording the program data and set a recording start position at which the recording of the program data is started as a playback start position, and when it is determined that the viewer is present during recording of the program data, the recording and playback controller is configured to start playing back the program data from the playback start position while continuing to record the program data.

2. The recording and playback device of claim 1, wherein when it is determined that the viewer is absent again during playing back of the program data, the recording and playback controller is configured to stop playing back the program data and set a playback stop position at which the playing back of the program data is stopped as the playback start position.

3. The recording and playback device of claim 1, wherein when the recording of the program data is completed while it is determined that the viewer is absent, the recording and playback controller is configured to cause the recording and playback device to make a transition to a power saving state.

4. The recording and playback device of claim 3, further comprising a return module configured to cause the recording and playback device to return from the power saving state to a normal power state,
wherein after the return module causes the recording and playback device to return from the power saving state, the recording and playback controller is configured to start playing back, from the playback start position, the program data which is recorded immediately before the transition is made to the power saving state.

5. The recording and playback device of claim 4, wherein the return module is configured to cause the recording and playback device to return from the power saving state to the normal power state based on the detection signal from the detector.

6. The recording and playback device of claim 1, wherein the recording and playback controller is configured to clear the playback start position when a playback position at which the program data is played back has reached the end of the program data.

7. The recording and playback device of claim 1, wherein the detector is a reflection or pyroelectric infrared sensor, and if no change occurs in a distance between the detector and the object detected by the detector or a movement of the object detected by the detector for a first predetermined period, the determination module is configured to determine that the viewer is absent, and if a change occurs in the distance or the movement for more than a second predetermined period, the determination module is configured to determine that the viewer is present.

8. A recording and playback method comprising:
receiving, using a tuner, a broadcast wave including program data;
displaying, using a display, the program data;
detecting, using a detector, an object which is present in a direction of a display screen of the display by using infrared rays;
determining, using a determination module, a presence or absence of a viewer based on a detection signal from the detector; and
recording and playback, using a recording and playback controller, the program data in accordance with the determination result,
wherein when it is determined that a viewer is absent, the recording and playback controller is configured to start recording the program data and set a recording start position at which the recording of the program data is started as a playback start position, and when it is determined that the viewer is present during recording of the program data, the recording and playback controller is configured to start playing back the program data from the playback start position while continuing to record the program data.

9. A computer program product having a computer readable medium including programmed instructions, wherein the instructions, when executed by a computer, cause the computer to perform:
receiving, using a tuner, a broadcast wave including program data;
displaying, using a display, the program data;
detecting, using a detector, an object which is present in a direction of a display screen of the display by using infrared rays;
determining, using a determining module, a presence or absence of a viewer based on a detection signal from the detector; and
recording and playback, using a recording and playback controller, the program data in accordance with the determination result,
wherein when it is determined that a viewer is absent, the recording and playback controller is configured to start recording the program data and set a recording start position at which the recording of the program data is started as a playback start position, and when it is determined that the viewer is present during recording of the program data, the recording and playback controller is configured to start playing back the program data from the playback start position while continuing to record the program data.
